(19) United States
(12) Patent Application Publication
(10) Pub. No.: US 2026/0084254 A1
(43) Pub. Date: Mar. 26, 2026

(54) CNC LATHE LIVE RADIAL TOOL SPACER

(71) Applicant: Jamey Hankins, Mesick, MI (US)

(72) Inventor: Jamey Hankins, Mesick, MI (US)

(73) Assignee: Jamey Hankins, Mesick, MI (US)

(21) Appl. No.: 18/893,725

(22) Filed: Sep. 23, 2024

(51) Int. Cl. B23Q 3/155

(52) U.S. Cl. CPC B23Q 3/155; B23Q 2003/15586; B23Q 2220/002

(57) ABSTRACT

A live radial tool spacer including a housing having an elongated connector configured to interface with a turret and a tool holder interface configured to support a tool holder. The live radial tool spacer extends a tool connected to the tool holder out from the turret, thereby proving improved clearance and accuracy during machining.

### TECHNICAL FIELD

The present disclosure relates to machine tools, and more specifically to a live radial tool spacer.

### BACKGROUND

Machine tools, such as lathes or computer numeric control (CNC) machines, use different tools to cut a workpiece. Such machine tools include means to constrain movement of the workpiece while a tool (such as for cutting, boring, grinding, shearing, or creating other forms of deformations) may be used for machining the workpiece. Some machine tools support multiple tools simultaneously, such as on a rotatable turret, for example. Multiple tools are attached to the turrets that allow the machine tool to easily switch between use of different tools, and accordingly create different cuts on a workpiece. The tools are attached to the turret using tool holders that are either defined on the turret, or removably fixed to the turret.

However, existing tool holders have a short length, and are often too close to the turret, which implies that tools are also too close to the turret. The position of the tools with respect to the turret determines the range of motion of the tool during machining. When the tools are too close to the turret, parts of the turret and other tools attached to the turret may cause obstructions during machining of certain parts of the workpiece. While some existing solutions include the use of tools with increased lengths to reach the workpiece, such solutions have reduced accuracy of cutting/machining and cause chatter in the parts being manufactured. Further, longer tools are expensive to make, require the use of more rigid materials to handle, increases stress during machining, and are likely to wear out more quickly. Additionally, existing solutions have increased potential for scraps during machining.

Therefore, there is a need for a device for machine tools that solves the problems arising from placing the tools too close to the turrets.

### SUMMARY

Aspects of the present disclosure are directed to a spacer. The spacer includes a housing having an elongated connector configured to interface with a turret, and a tool holder interface configured to support a tool holder.

In some embodiments, the housing may include a hollow cavity configured to accommodate a shaft, where the shaft may be configured to engage with an extension shaft of the tool holder.

In some embodiments, the shaft is mounted with one or more bearings.

In some embodiments, the turret includes a driving means which may be configured to drive the extension shaft through the shaft of the spacer.

In some embodiments, the shaft is configured to drive the extension shaft which may linearly extend and/or retract a tool attached to the tool holder.

In some embodiments, the housing includes a fastening means which may be configured to fasten the spacer to the turret and/or the tool holder.

In some embodiments, the fastening includes one or more holes in the housing, where the one or more holes may be configured to allow the housing to be fastened to the tool holder and/or the turret using one or more corresponding screws.

In some embodiments, the one or more holes are at least one of threaded holes or clearance holes.

In some embodiments, the one or more screws are socket head cap screws.

In some embodiments, the tool holder interface is defined on at least one of, a longitudinal end of the housing or a radial side of the housing.

In some embodiments, the housing is between about 1″ to 3″ in length.

In some embodiments, the housing is made of steel.

Aspects of the present disclosure are directed towards a spacer including a housing having an elongated connector configured to interface with a turret, and a tool interface configured to support a tool.

In some embodiments, the housing is between about 1″ to 3″ in length.

In a further aspect, the present disclosure is directed to a turret including a detachable spacer having at least one of, a tool holder interface or a tool interface.

Additional aspects related to this disclosure are set forth, in part, in the description which follows, and, in part, will be obvious from the description, or may be learned by practice of this disclosure.

It is to be understood that both the forgoing and the following descriptions are exemplary and explanatory only and are not intended to limit the claimed disclosure or application thereof in any manner whatsoever.

### BRIEF DESCRIPTION OF THE DRAWINGS

FIGS. 1A and 1B illustrate a first isometric view and a side view, respectively, of a spacer, according to embodiments of the present disclosure.

FIG. 1C illustrates an exploded view of the spacer, according to embodiments of the present disclosure.

FIGS. 1D and 1E illustrate a second isometric view and a bottom view, respectively, of the spacer, according to embodiments of the present disclosure.

FIGS. 1F and 1G illustrate views of the spacer attached to a tool, according to embodiments of the present disclosure.

FIGS. 2A and 2B illustrate a disassembled view and an assembled view, respectively, of the spacer being connected to a turret and the tool, according to embodiments of the present disclosure.

### DETAILED DESCRIPTION

The particulars shown herein are by way of example and for purposes of illustrative discussion of the various embodiments only and are presented in the cause of providing what is believed to be the most useful and readily understood description of the principles and conceptual aspects of the methods and compositions described herein. In this regard, no attempt is made to show more detail than is necessary for a fundamental understanding, the description making apparent to those skilled in the art how the several forms may be embodied in practice.

The present disclosure will now be described by reference to more detailed embodiments. This present disclosure, however, is embodied in different forms and should not be construed as limited to the embodiments set forth herein. Rather, these embodiments are provided so that this disclosure will be thorough and complete, and will fully convey the scope to those skilled in the art.

Unless otherwise defined, all technical and scientific terms used herein have the same meaning as commonly understood by those skilled in the art to which the present disclosure belongs. The terminology used in the description herein is for describing particular embodiments only and is not intended to be limiting. As used in the description and the appended claims, the singular forms ‘a,’ ‘an,’ and ‘the’ are intended to include the plural forms as well, unless the context clearly indicates otherwise.

Unless indicated to the contrary, the numerical parameters set forth in the following specification and attached claims are approximations that may vary depending upon the desired properties sought to be obtained and thus may be modified by the term about. At the very least, and not as an attempt to limit the application of the doctrine of equivalents to the scope of the claims, each numerical parameter should be construed in light of the number of significant digits and ordinary rounding approaches.

Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

As used herein, “substantially” means largely or considerably, but not necessarily wholly, or sufficiently to work for the intended purpose. The term “substantially” thus allows for minor, insignificant variations from an absolute or perfect state, dimension, measurement, result, or the like, as would be expected by a person of ordinary skill in the art, but that do not appreciably affect overall performance.

As used herein, “about” means approximately or nearly, and in the context of a numerical value or range set forth means ±15% of the numeric value.

Existing tools are directly attached to machine tools (such as lathes) using tool holders. Tool holders are often used in turrets, to which multiple tools are attached to allow the machine tool to easily switch between use of different tools, and accordingly create different cuts on a workpiece. However, existing tool holders often attach the tools too close to the turrets, which increases chances of parts of the turret coming into contact with the workpiece and prevent the tool from reaching portions of the workpiece. The present disclosure solves at least the aforementioned problem by providing a spacer that separates the tools/tool holder from the turret by a predetermined distance.

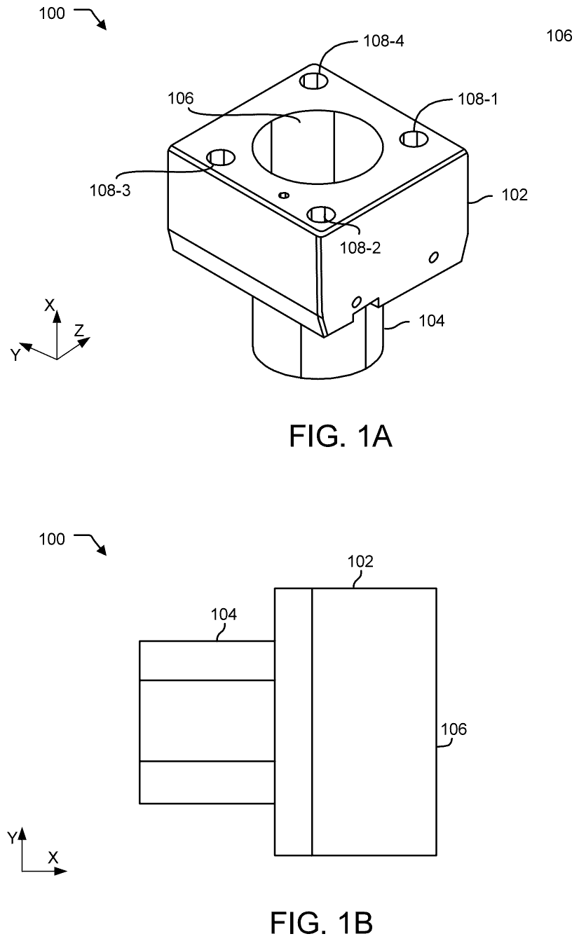

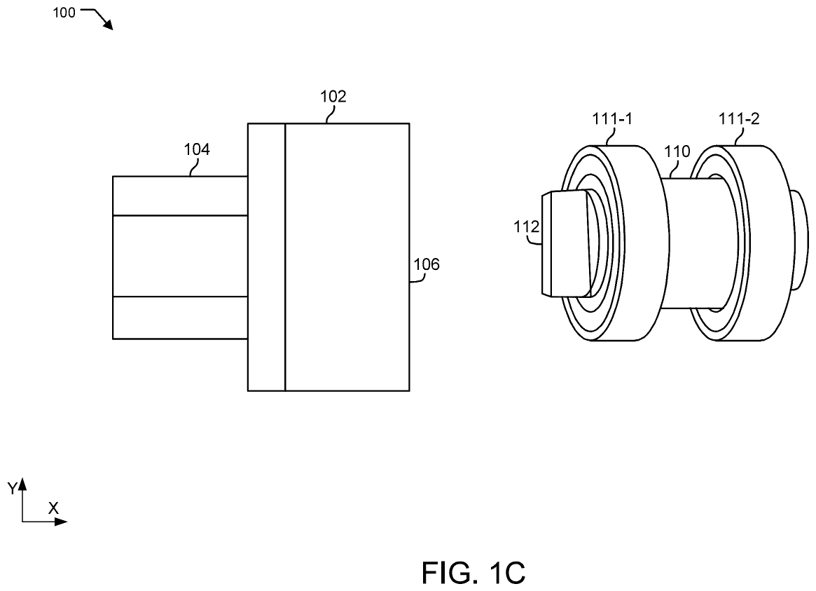

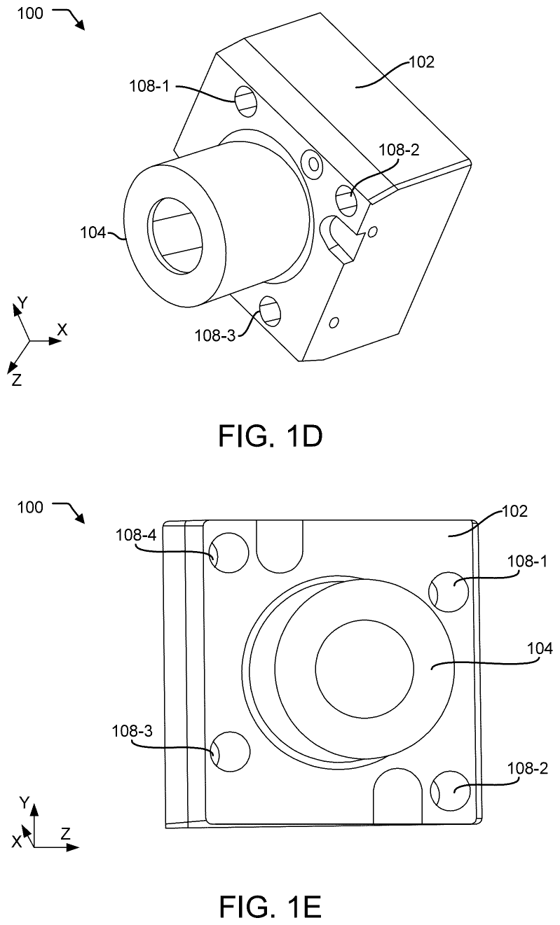

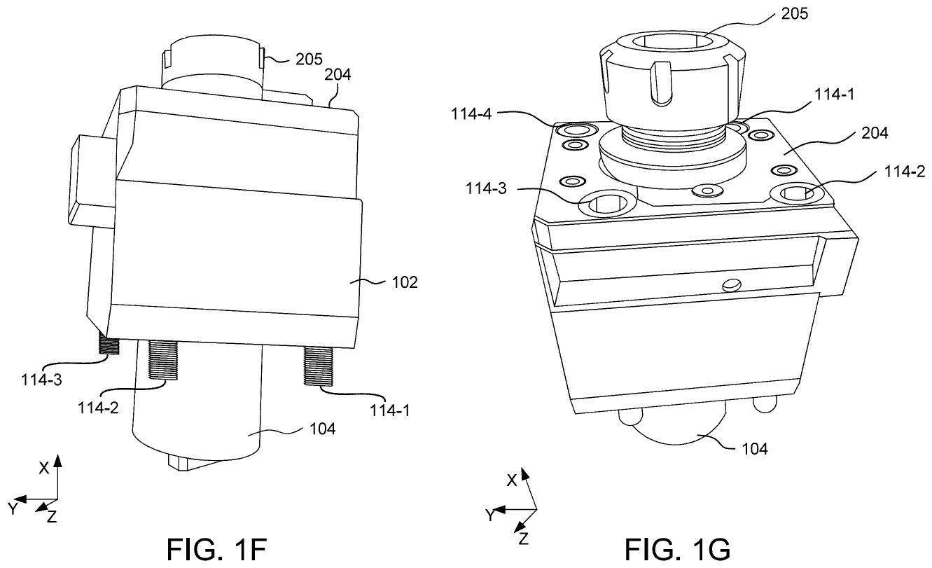

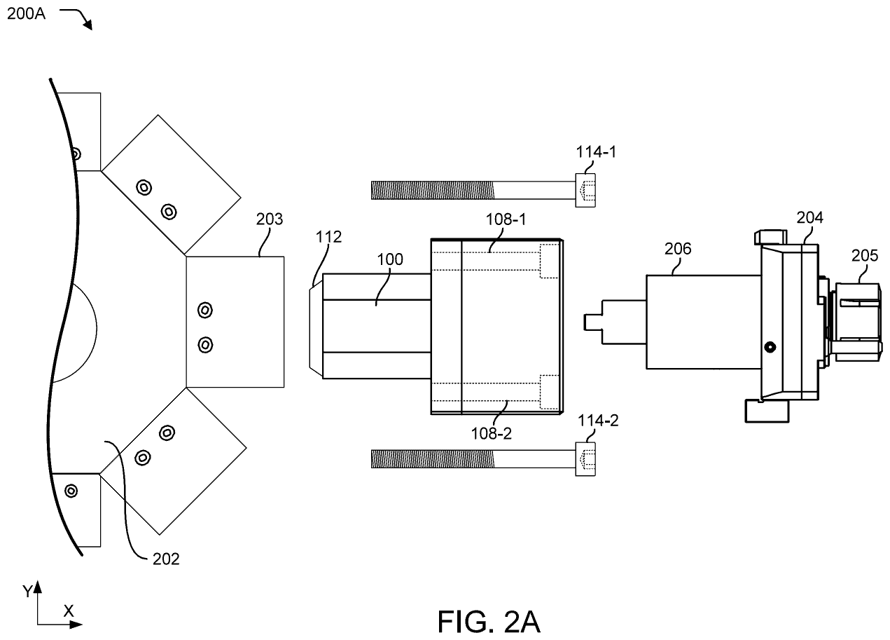

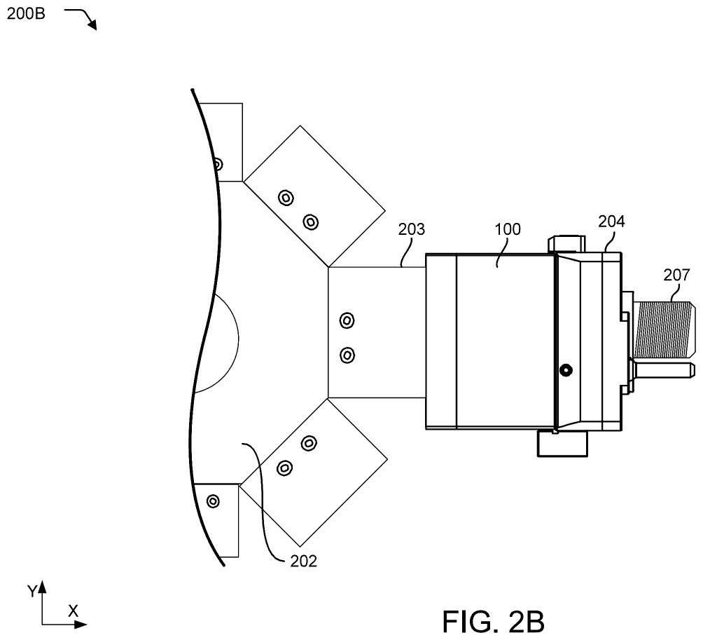

Various details of the present disclosure are described in reference to FIGS. 1A to 2B.

Referring to FIGS. 1A to 1E, a spacer 100 includes a housing 102 having an elongated connector 104 configured to interface with a turret (such as turret 202 shown in FIGS. 2A and 2B), and a tool interface or a tool holder interface 106 configured to interface with and support a tool or a tool holder (such as tool holder 204 shown in FIGS. 2A and 2B), respectively. The turret 202 may be associated with a machine tool, such as a lathe, but is not limited to the like.

The spacer 100 may be securely attached to the turret 202 using the elongated connector 104. The spacer 100 may be configured to accommodate, either directly or through the tool holder 204, any tool used for at least one of, cutting, boring, grinding, shearing, or creating other forms of deformations in a workpiece (not shown).

The housing 102 of the spacer 100 may be configured to separate the turret 202 from the tool by a predetermined distance. The length of the housing 102 may correspond to the distance of separation between the tool holder 204 and the turret 202. In some embodiments, the housing 102 may be between about 1″ to about 3″ in length. For example, the housing 102 may be about 2.5″ in length. It is appreciated by those skilled in the art that the length (and other dimensions of the housing 102) may be suitably adapted based on requirements.

In some embodiments, the housing 102 may be substantially cuboidal in shape. In other embodiments, the housing 102 may be substantially cylindrical in shape. In some embodiments, the shape of the housing 102 may be configured to match that of the tool holder 204.

In other embodiments, the housing 102 may be defined with a shape that minimizes obstruction during movement of the turret 202. In some embodiments, the housing 102 may have different shapes along different portions of the length thereof. For example, the housing 102 may have a heterogenous shape, such as a substantially cylindrical shape for a first 1″ of length from the elongated connector 104, and a substantially cuboidal shape for the next 2″ of length. Further, the dimensions, including thickness, width, and diameter, of the housing 102 may be suitably adapted/selected based on required rigidity, weight, materials used, size of the tool holder, and the like, but not limited thereto. It may be appreciated by those skilled in the art that the housing 102 may be suitably adapted to have any prismatic whose dimensions are optimized for providing clearance for the tools from the turret 202, providing rigidity during the machining of a workpiece, and the like.

In some embodiments, the housing 102 may be made of rigid materials capable of withstanding forces experienced during machining of the workpiece. In some embodiments, the housing 102 may be made of materials that are at least harder than the workpiece. Using materials harder than the workpiece may prevent the housing 102 from bending or contouring during machining, thereby increasing the accuracy and/or precision of the cuts. In some embodiments, the housing 102 may be made of steel. In an example, the housing 102 may be made from milder steel 4140. The grade of steel used to make the housing 102 may be selected based on the requirements for hardness, as well as weight requirements/restrictions. In other embodiments, other materials may be used based on the hardness of the workpiece.

In some embodiments, the elongated connector 104 and the tool holder interface 106 may be defined on opposite surfaces of the housing 102, as shown in the FIG. 1A and 1B. In such embodiments, the tool holder interface 106 may be defined on a longitudinal end of the housing 102. Further, in such embodiments, the turret 202 may be configured to move the tool and cut the workpiece along the length thereof. In other embodiments, the elongated connector 104 and the tool holder interface 106 may be defined on adjacent surfaces of the housing 102. In such embodiments, the tool holder interface 106 may be defined on a radial side of the housing 102. Further, in such embodiments, the turret 202 may be configured to move the tool perpendicularly to the length of the workpiece, to make cuts on a frontal surface of the workpiece.

In some embodiments, the housing 102 may be made as a solid block, with the elongated connector 104 extending from the housing 102, and the tool holder interface 106 being defined on a surface of the housing 102. In other embodiments, the housing 102 may be hollow. The housing 102 may include a hollow cavity defined along the length thereof. The hollow cavity may be cylindrical or prismatic in shape. In some embodiments, the shape and dimensions of the hollow cavity may be heterogenous along the length of the housing 102. In such embodiments, the hollow cavity may be configured to accommodate irregularly shaped elements therein, such as a bearing-mounted shaft. It may be appreciated by those skilled in the art that the hollow cavity may be suitably adapted based on machining requirements, type of elements disposed therein, and the like, while ensuring the housing 102 remains sufficiently rigid during machining of the workpiece. In some embodiments, the housing 102 may include internal structures (not shown) for reinforcing strength and structural integrity of the housing 102.

Referring to FIG. 1C, the spacer 100 may include a shaft 110 disposed within the housing 102, or the hollow cavity thereof. In some embodiments, the shaft 110 may be either fixedly or slidably disposed within the housing 102, as shown in FIG. 1C. In some embodiments, the shaft 110 may be substantially cylindrical or cuboidal in shape. In some embodiments, one or more bearings (such as bearings 111-1 and 111-2, collectively referred to as bearings 111) may be mounted on the shaft 110. The bearings 111 may allow the shaft 110 to rotate independently of the housing 102. In some examples, the bearings 111 may be rotating-element bearings, such as a ball bearing, a roller bearing, and the like. In other examples, the bearings 111 may be any one or a combination of fluid bearings (such as lubricants disposed between the shaft 110 and the housing 102), magnetic bearings, jewel bearings, and the like. The geometry of bearings 111 may be suitably adapted based on the shape of the shaft 110. For example, when the shaft 110 is substantially cylindrical, the bearings 111 may be ring-shaped. In other examples where the shaft 110 is substantially cuboidal, the bearings 111 may include an inner ring having a square internal surface and a circular outer surface.

In some embodiments, the shaft 110 may be configured to communicate rotational motion of a driving means (not shown) of the turret 202 to an extension shaft 206 (shown in FIG. 2A) of the tool holder 204. The driving means may be a spindle on the turret 202 configured to drive live tools through the extension shaft 206 and the shaft 110. In other embodiments, the shaft 110 may be configured to allow the extension shaft 206 to be driven to linearly extend and/or retract a tool attached to the tool holder 204.

In some embodiments, the shaft 110 may include an engagement member 112 defined on a first end of the shaft 110. The engagement member 112 may be configured to engage with the driving means, such as when the spacer 100 is (removably) fixed to the turret 202. In some embodiments, the geometry of the engagement member 112 may be suitably adapted to fit into corresponding member/interfaces on the driving means. The geometry of the engagement member 112 may correspond to the geometry of the driving means to prevent any slack therebetween.

In some embodiments, the shaft 110 may be disposed within the elongated connector 104. In such embodiments, the hollow cavity may extend from the housing 102 and through the elongated connector 104. In some embodiments, the engagement member 112 may be configured to protrude out from the elongated connector 104, such as in the longitudinal axis of the spacer 100. The geometry of the engagement member 112 may be similar/identical to portions of the extension shaft 206 of the tool holder 204 that are configured to engage with the driving means (such as when the spacer 100 is not used). While FIG. 1C illustrates the engagement member 112 as a male member engaging with a corresponding female member on the driving means, other implementations may include the driving means having a male member that couples to a corresponding female member defined on the engagement member 112.

In some embodiments, the shaft 110 may include a provision (not shown) on a second end of the shaft 110. The first end and the second end may be opposite ends of the shaft 110. In some embodiments, the provision may allow the shaft 110 to be rotationally coupled to the extension shaft 206. The geometry of the provision may correspond to portions of the extension shaft 206. While FIG. 1C illustrates the extension shaft 206 including a male member that couples to the provision having a corresponding female member, in other implementations, the extension shaft 206 may include a female member that is configured to couple with the provision having a corresponding male member.

Referring to FIGS. 1D and 1E, the elongated connector 104 may extend out from a bottom side/surface of the spacer 100. As shown, the elongated connector 104 may be hollow to accommodate the shaft 110 therein. A first end of the hollow portion of the elongated connector 104 may be defined as the tool holder interface 106 on a top side of the housing 102 (as shown in FIG. 1A), and a second end of the hollow portion may allow the engagement member 112 to protrude out from the second end (as shown in FIGS. 1D and 1E). In some embodiments, the elongated connector 104 may also allow the extension shaft 206 to be inserted thereinto to form a connection with the driving means through the shaft 110. The extension shaft 206 may be inserted through the tool holder interface 106, as shown in FIG. 1A.

Referring to FIG. 1A, and 1D to 1G, the spacer 100 may include a fastening means to hold/secure the spacer 100 to either the turret 202, or the tool holder 204, or both. The fastening means may be any or a combination of screws (such as socket head cap screws 114-1 to 114-4, collectively referred to as socket head cap screws 114), nails, rivets, welds, adhesives, bolts and nuts, hook-and-slot fasteners, interlocking elements, and the like, but not limited thereto. In some embodiments, the fastening means may be configured to fit into or engage with one or more holes, such as holes 108-1 to 108-4 (collectively referred to as holes 108), in the housing 102.

In some embodiments, the holes 108 may be defined along the length of the housing 102. In some embodiments, the holes 108 may be configured to allow the housing 102 to be fastened to the tool holder 204 and/or the turret 202 using one or more corresponding screws (or any other fastening means). In some embodiments, the length of the screws may be greater than the length of the housing 102. In some embodiments, the holes 108 may be threaded holes or clearance holes. In embodiments where the holes 108 are threaded, the fastening means may have a corresponding set of threads. In some embodiments, the screws may be socket head cap screws 114, as shown in FIGS. 1F and 1G. As a non-limiting example, the socket head cap screws 208 may be characterized by the dimensions M12×1.75×100 mm. The socket head cap screws 114-1 to 114-4 may be configured to fit into the holes 108-1 to 108-4, respectively. The socket head cap screws 114-1 to 114-4 may include a threaded portion, which may engage with corresponding threaded portions in the turret 202 to secure the spacer 100 with the turret 202. While embodiments of the present disclosure are described in the context of the spacer 100 having four holes 108 that accommodate four socket head cap screws 114, it is appreciated by those skilled in the art that the spacer 100 may be suitably adapted to have any number of holes 108 and socket head cap screws 114, based on requirements of the use case, for securing the spacer 100 to the turret 202 and/or the tool holder 204.

In embodiments where the holes 108 are clearance holes, the socket head cap screws 114 may be inserted through a first end of the holes 108 (such as from the top side of the housing 102 as shown in FIG. 1A), and a set of nuts may be tightened on a portion of the socket head cap screws 114 protruding out from a second end of the holes 108 (such as from the bottom side of the housing 102 as shown in FIGS. 1D to 1G). The protruding portions of the socket head cap screws 114, as shown in FIGS. 1F and 1G, may be configured to engage with or pass through corresponding receiving portions (not shown) at the turret 202 to secure the spacer 100 thereto. The turret 202 may be secured between the nut and the spacer 100/housing 102.

FIGS. 1F and 1G illustrate example representations of the tool holder 204 assembled/secured to the spacer 100 using a fastening means, such as the socket head cap screws 114. As shown, the tool holder 204 may also include orifices corresponding to the holes 108, which allow the spacer 100 to be secured between the turret 202 and the tool holder 204 using the socket head cap screws 114. In some embodiments, the length of the socket head cap screws 114 may be greater than the length of the tool holder 204 and the housing 102. The socket head cap screws 114 may be inserted through the orifices of the tool holder 204, and the portion of the socket head cap screws 114 extending from the tool holder 204 may be inserted through the holes 108, as shown in FIGS. 1F and 1G. Thereafter, the portion of the socket head cap screws 114 protruding out from the bottom side of the spacer 100/housing 102 may be inserted into the turret 202 (such as the receiving portions thereof), to secure the tool holder 204, the spacer 100, and the turret 202 together.

FIGS. 2A and 2B illustrate disassembled view 200A and assembled view 200B of the spacer 100, the turret 202, and the tool holder 204.

In some embodiments, the turret 202 may be any turret known to those skilled in the art. For example, the turret 202 may be turrets associated with computer numeric control (CNC) lathes. The turret 202 may be configured to move in any of the three dimensions with respect to the workpiece. The movement and rotation of the turret 202 may be enabled by a corresponding spindle attached thereto.

In some embodiments, the turret 202 may have a substantially circular contour in at least one direction, and may be configured to rotate to switch between one of multiple tools attached thereto. In some embodiments, the turret 202 may include one or more of an interfacing element 203 that allows at least one of the spacer 100, the tool holder 204, or the tool to be attached thereto. In some embodiments, the interfacing element 203 may be configured to receive and secure the spacer 100 through the elongated connector 104, as shown in the assembled view 200B. In some embodiments, the interfacing element 203 may also be configured to expose the driving means to the shaft 110 within the spacer 100, thereby allowing the driving means to drive the tool through the shaft 110 and the extension shaft 206.

In some embodiments, the tool holder 204 may be any tool holder known to those skilled in the art. As a non-limiting example, the tool holder 204 may be Lathe Linear Unit (LLU), such as LLU-60-1-R tool holder. In other examples, the tool holder 204 may be a lathe angular unit. In some embodiments, the tool holder 204 may include a tool interface to engage with and secure the tool thereto. In some embodiments, the tool interface may be a chuck, a collet, a shrink fit holder, a quick-change tool holder, and the like, but not limited thereto.

In some embodiments, the tool holder 204 may include a cap 205 (shown in FIGS. 1F, 1G, and 2A) put over a spindle output interface 207 (shown in FIG. 2B). The tool may be removably fixed to the tool holder 204 through the spindle output interface 207. In some embodiments, the spindle output interface 207 may include a threaded portion that engages with a corresponding set of threads (not shown) on the tool. In some embodiments, the tool holder 204 may include an external coolant configured to disperse a fluid to maintain an optimal temperature at the tool.

In some embodiments, the tool holder 204 may be secured to the spacer 100 using the extension shaft 206. The extension shaft 206 may be inserted into the tool holder interface 106 on the housing 102. In some embodiments, the extension shaft 206 may be configured to engage with the provision on the shaft 110, thereby allowing the extension shaft 206 to be driven by the driving means in the turret 202 via the shaft 110.

In some embodiments, once the turret 202, the spacer 100, and the tool holder 204 are assembled (in that order), the fastening means at the tool holder interface 106 may be used to fasten/secure the spacer 100 to the turret 202 and/or the tool holder 204.

In some embodiments, to use the spacer 100, a user may place the spacer 100 over the turret 202 (or the interfacing element 203 thereof). Further, the user may place the tool holder 204 over the spacer 100, and insert fastening means (such as screws, bolts, or nails) through the holes 108 and/or the orifices. Before the turret 202 initiates cutting of the workpiece, the turret 202 may use in-built tool measurement systems, such as those using touch probes, to calibrate position and length of the tool. The machine tool may be configured to determine the position and length of the tool as an offset. The offset may be used by the machine tool to account for the spacer 100 which separates the tool from the turret 202 by the predetermined distance.

In other embodiments, the housing 102 may include the tool interface, instead of the tool holder interface. In such embodiments, the tools may be directly attached to the housing 102, and the spacer 100 may be secured to the turret 202 using any of the fastening means. In further embodiments, the spacer 100 may be implemented as a detachable tool holder 204.

Hence, the spacer 100 of the present disclosure allows for the extension of the tool connected to the tool holder 204 out from the turret 202, thereby providing improved clearance and accuracy during machining. The spacer 100 also extends the life of the tool, and thereby reduces manufacturing costs of the workpiece. The spacer 100 also reduces scraps and cutter usage due to the increased spacing/distance between the turret 202 and the tool. Further, the interfaces used by the spacer 100 to connect to the turret 202 and the tool holder 204 (or the tool) do not require modifications to be made to the turret 202, or any other component associated with the machine tool.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A spacer, comprising:
a housing comprising:
an elongated connector configured to interface with a turret; and
a tool holder interface configured to support a tool holder.

2. The spacer of claim 1, wherein the housing comprises a hollow cavity configured to accommodate a shaft, and wherein the shaft is configured to engage with an extension shaft of the tool holder.

3. The spacer of claim 2, wherein the shaft is mounted with one or more bearings.

4. The spacer of claim 2, wherein the turret comprises a driving means configured to drive the extension shaft through the shaft of the spacer.

5. The spacer of claim 2, wherein the shaft is configured to drive the extension shaft to linearly extend and/or retract a tool attached to the tool holder.

6. The spacer of claim 1, wherein the housing comprises a fastening means configured to fasten the spacer to the turret and/or the tool holder.

7. The spacer of claim 6, wherein the fastening means comprises one or more holes in the housing, and wherein the one or more holes are configured to allow the housing to be fastened to the tool holder and/or the turret using one or more corresponding screws.

8. The spacer of claim 7, wherein the one or more holes are at least one of: threaded holes or clearance holes.

9. The spacer of claim 7, wherein the one or more screws are socket head cap screws.

10. The spacer of claim 1, wherein the tool holder interface is defined on at least one of a longitudinal end of the housing or a radial side of the housing.

11. The spacer of claim 1, wherein the housing is between about 1″ to about 3″ in length.

12. The spacer of claim 1, wherein the housing is made of steel.

13. A spacer, comprising:
a housing comprising:
an elongated connector configured to interface with a turret; and
a tool interface configured to support a tool.

14. The spacer of claim 13, wherein the housing is between about 1″ to about 3″ in length.

15. A turret, comprising a detachable spacer having at least one of: a tool holder interface or a tool interface.
